(19) United States
(12) Patent Application Publication
(10) Pub. No.: US 2015/0120217 A1
(43) Pub. Date: Apr. 30, 2015

(54) METHOD FOR ESTIMATING TORQUE TRANSMISSION CHARACTERISTICS OF DRY TYPE CLUTCH

(71) Applicants: Hyundai Motor Company, Seoul (KR); Kia Motors Corp., Seoul (KR)

(72) Inventors: Ho Young Lee, Bucheon-si (KR); So Young Lee, Seoul (KR); Young Min Yoon, Seoul (KR); Jin Sung Kim, Seoul (KR); Seung Sam Baek, Jeju-si (KR)

(73) Assignees: Hyundai Motor Company, Seoul (KR); Kia Motors Corp., Seoul (KR)

(21) Appl. No.: 14/295,126

(22) Filed: Jun. 3, 2014

(30) Foreign Application Priority Data
Oct. 29, 2013 (KR) 10-2013-0129290

(51) Int. Cl. G01M 13/02; G01L 3/02

(52) U.S. Cl. CPC G01M 13/022; G01L 3/02
USPC 702/41

(57) ABSTRACT

A method for estimating torque transmission characteristics of a dry type clutch may include a data receiving step for receiving information of an estimated point representing torque transmission of the clutch according to an actuator stroke acquired in real time while a vehicle is travelling, a reference points moving step for moving a series of four reference points selected on an existing line representing a change in the torque transmission of the clutch according to the actuator stroke, based on the received information of the estimated point, and an update step for newly plotting a line representing the change in the torque transmission of the clutch according to the actuator stroke, using the four reference points which have been moved.

### CROSS-REFERENCE TO RELATED APPLICATION

The present application claims priority of Korean Patent Application Number 10-2013-0129290 filed on Oct. 29, 2013, the entire contents of which application are incorporated herein for all purposes by this reference.

### BACKGROUND OF INVENTION

1. Field of Invention

The present invention relates to a method for estimating the torque transmission characteristics of a dry type clutch, and more particularly, to a method for estimating in real time a map related to the torque transmission characteristics of a dry type clutch according to the working stroke of an actuator so as to utilize it in controlling the dry type clutch, in operating the dry type clutch used in an automated manual transmission mounted on a vehicle.

2. Description of Related Art

Recent automated manual transmissions are typical systems configured for automatically controlling a conventional manual transmission, and among them, there is a type configured for receiving the torque from an engine using a dry type clutch, unlike a generic A/T which employs a torque converter and a wet type multi-plate clutch.

Since the dry type clutch used in an automated manual transmission as described above has characteristics of the torque transmitted to the clutch being changed greatly in real time according to a variety of factors such as parts tolerance, wear resulting from usage over time, thermal strain from high temperature in components and changes in the coefficient of friction of discs or plates, there is a disadvantage that it is difficult to accurately estimate the torque transmitted by means of the clutch while a vehicle is travelling.

On the one hand, if a clutch is controlled while not knowing the changes in the torque transmission of a dry type clutch in an automated manual transmission, since the clutch slips too much or shocks are caused thereto so to deteriorate the drivability of a vehicle, it is desirable to identify the torque characteristics of a dry type clutch in real-time as much as possible when a vehicle is travelling and to control an actuator accordingly.

However, currently it is almost impossible or costs too much to directly measure the amount of torque transmission by a clutch, and thus a method is mainly considered for estimating or correcting in real time a T-S curve (torque-stroke curve) made into a map from the torque transmission of a clutch according to the working stroke of an actuator, as shown in FIG. 1.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention is designed in accordance with the need as described above, and various aspects of the present invention provide for a method for estimating the torque transmission characteristics of a dry type clutch so as to more appropriately control the dry type clutch and to ultimately improve the drivability of a vehicle having an automated manual transmission mounted thereon, by making it possible to estimate in real time a map of torque transmission of the clutch according to the working stroke of an actuator of the dry type clutch used in the automated manual transmission while the vehicle is running.

Various aspects of the present invention provide for a method for estimating the torque transmission characteristics of a dry type clutch in accordance with the present invention may include: a data receiving step for receiving information of an estimated point representing torque transmission of the clutch according to an actuator stroke acquired in real time while a vehicle is travelling, a reference points moving step for moving a series of four reference points selected on an existing line representing a change in the torque transmission of the clutch according to the actuator stroke, based on the received information of the estimated point, and an update step for newly plotting a line representing the change in the torque transmission of the clutch according to the actuator stroke, using the four reference points which have been moved.

According to one aspect of the present invention, the four reference points located on the line representing the change in the torque transmission of the clutch according to the actuator stroke may be selected such that, with respect to a midpoint of a full range of the torque transmission a clutch can exert, two reference points are located in a low torque region where the torque transmission of the clutch is relatively low and the other two reference points are located in a high torque region where the torque transmission of the clutch is relatively high. A reference point which has the lowest torque transmission of the clutch among the four reference points may be a touch point of the clutch.

According to another aspect of the present invention, the two reference points selected in the low torque region represent a linear change interval in the torque transmission of the clutch according to the actuator stroke in the low torque region and the two reference points selected in the high torque region represent a linear change interval in the torque transmission of the clutch according to the actuator stroke in the high torque region, thereby ensuring drivability of the vehicle while performing control of the clutch.

In some aspects of the present invention, the two reference points selected in the low torque region among the four reference points that have been moved may be connected by a straight line, the two reference points selected in the high torque region among the four reference points that have been moved may be connected by a straight line, and two middle reference points among the four reference points that have been moved may be connected by a portion of a spline curve that passes through the four reference points.

In other aspects of the present invention, wherein in the reference points moving step, a position corresponding to the torque transmission of the same magnitude as the estimated point entered in the data input step may be selected on the existing line representing the change in the torque transmission of the clutch according to the actuator stroke as a present point, and the four reference points are moved based on a difference in stroke between the present point and the estimated point. When the four reference points are moved according to the difference in the stroke between the present point and the estimated point in the reference points moving step, an amount of movement of the four reference points may vary in a direction of torque transmission and in a direction of stroke according to a relative positional difference between the four reference points and the estimated point.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph illustrating a conventional T-S curve;

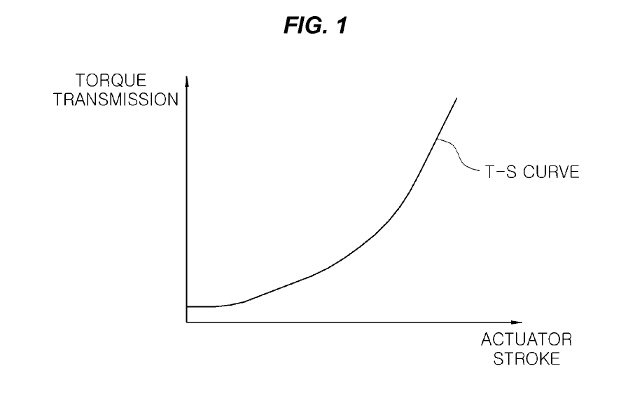

FIG. 2 is a diagram conceptually illustrating the structure of a dry type dual clutch used in a DCT as an example of a dry type clutch according to a related art;

FIG. 3 is a flow chart illustrating an exemplary method for estimating torque transmission characteristics of a dry type clutch in accordance with the present invention; and

FIG. 4 is a graph describing an exemplary procedure for newly estimating a T-S curve in accordance with the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

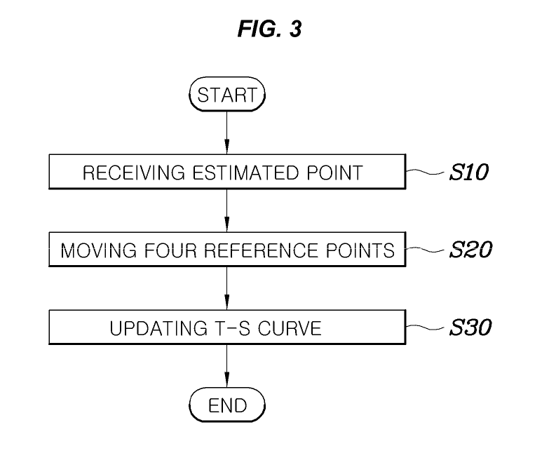

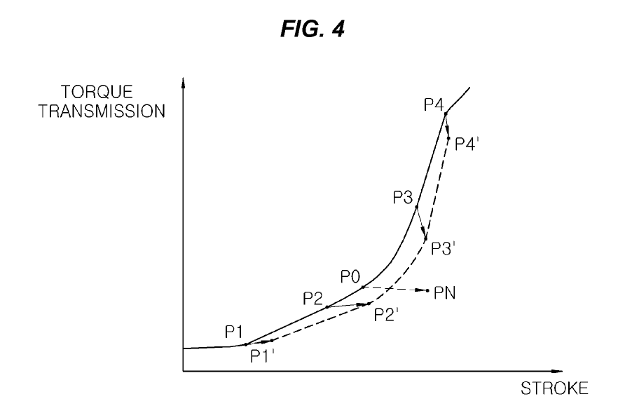

Referring to FIGS. 3 and 4, a method for estimating the torque transmission characteristics of a dry type clutch according to various embodiments of the present invention includes: a data receiving step S10 for receiving information of an estimated point PN representing the torque transmission of the clutch according to an actuator stroke acquired in real time while a vehicle is travelling; a reference points moving step S20 for moving a series of reference points such as four reference points P1, P2, P3, and P4 selected on an existing line representing a change in the torque transmission of the clutch according to the actuator stroke, based on the received information of the estimated point; and an update step S30 for newly plotting a line representing a change in the torque transmission of the clutch according to the actuator stroke, using the four reference points which have been moved.

In other words, four reference points on a T-S curve which has been used are moved according to an estimated point acquired in real time while a vehicle is travelling, and a new T-S curve is determined in real time through the update step S30 with the four reference points which have been moved as such, thereby estimating in real time the torque transmission characteristics of a dry type clutch.

Here, the acquiring of the estimated point may be carried out with other known techniques that have already been developed. That is, according to the present invention when the torque transmission is acquired in real time according to an actuator stroke while a vehicle is travelling by means of techniques of acquiring the torque transmission of a clutch according to an actuator stroke, which are already known or are being developed currently, the T-S curve which has been used is newly plotted using such stroke and torque transmission as the estimated point so as to be utilized in controlling the vehicle, reflecting on the changed clutch characteristics.

The four reference points P1, P2, P3, and P4 located on a line (i.e., the T-S curve) representing a change in the torque transmission of a clutch according to an actuator stroke are selected such that, with respect to the midpoint of the full range of the torque transmission a clutch can exert, two reference points P1 and P2 are located in the region where the torque transmission of the clutch is relatively low and the other two reference points P3 and P4 are located in the region where the torque transmission of the clutch is relatively high.

In particular, the reference point P1 which has the lowest torque transmission of the clutch among the four reference points is preferably a touch point of the clutch.

The two reference points selected in the region where the torque transmission of the clutch is relatively low and the two reference points selected in the region where the torque transmission of the clutch is relatively high, respectively, represent a linear change in the torque transmission of the clutch according to the actuator stroke and accordingly are selected as the two ends of the range that can ensure the drivability of a vehicle to be targeted even in performing the control of the clutch.

In other words, the interval between the two reference points selected in the region where the torque transmission of the clutch is relatively low may be connected with a straight line on the T-S curve without any problem, or is a linear interval of change in the torque transmission according to the stroke. So is the interval between the two reference points selected in the region where the torque transmission of the clutch is relatively high.

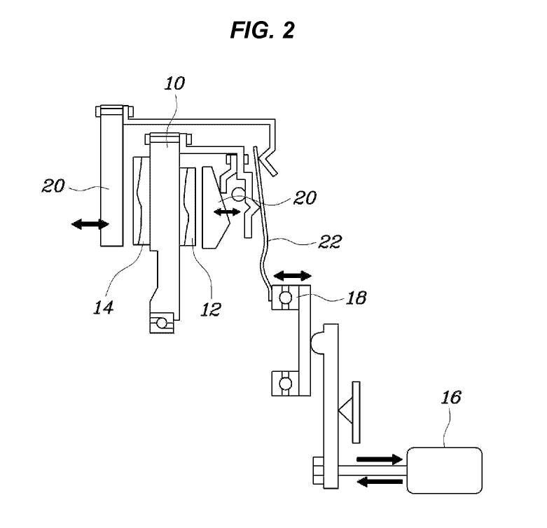

The reason why four reference points are to be used as above to update the T-S curve of a dry type clutch in the present invention is as follows, in conjunction with the conceptual diagram of the clutch shown in FIG. 2.

In FIG. 2, a first clutch disc 12 and a second clutch disc 14 are installed on both sides of a center support plate 10 so as to move axially to the left and right. The first clutch disc 12 and the second clutch disc 14, respectively, may be able to transmit power as the center support plate 10 is pressurized by a clutch pressure plate 20 that receives the linear displacement provided by a clutch actuator 16 through a clutch bearing 18, a diaphragm spring 22, and so on. Here, the first clutch disc 12 and the second clutch disc 14 respectively are of a constituent having a damping spring mounted thereon and fall within a known technology.

Meanwhile, simplifying the operative mechanism of a single clutch as a mass and a spring, then the stroke of the clutch pressure plate 20 could be simplified as a spring-mass system having two springs (a diaphragm spring and a damping spring) connected in series. For the displacement of the mass in such a spring-mass system, the initial displacement is affected by the spring with low stiffness (the diaphragm spring), the final displacement is affected by the spring with high stiffness (the damping spring), and the middle part therebetween is affected by a combination of the two springs.

With such a physical property, the low torque region of the T-S curve is affected by the stiffness of the diaphragm spring, the high torque region is affected by the stiffness of the damping spring, and the intermediate torque region therebetween is affected by the two springs at the same time. Hence, in consideration of such a property, the four reference points are selected as above so that the two reference points P1 and P2 at the lower part represent a linear change interval of the T-S curve for the low torque region and the two reference points P3 and P4 at the upper part represent a linear change interval of the T-S curve for the high torque region.

In the reference points moving step S20, a position corresponding to the torque transmission of the same magnitude as the estimated point PN entered in the data input step S10 is selected on the existing line representing the change in the torque transmission of the clutch according to the actuator stroke as a present point P0, and the four reference points P1, P2, P3, and P4 are moved based on the difference in the stroke between the present point P0 and the estimated point PN, as shown in FIG. 4.

When the four reference points are moved according to the difference in the stroke between the present point and the estimated point in the reference points moving step S20, the amount of movement of the four reference points varies in the direction of torque transmission (direction of the vertical axis) and in the direction of stroke (direction of the horizontal axis) according to the relative positional difference between the four reference points and the estimated point.

That is, in FIG. 4, P2 which has a relatively shorter horizontal distance to the estimated point moves more than P1 in the horizontal direction toward the estimated point for the reference points P1 and P2, and P3 which has a relatively shorter vertical distance to the estimated point moves more than P4 in the vertical direction toward the estimated point for the reference points P3 and P4.

Alternatively, a variety of different methods may be used for moving the four reference points depending on the position of the estimated point and the difference in the stroke difference between the present point and the estimated point.

In the update step S30, the interval between the two reference points located in the region where the torque transmission of the clutch is relatively low and the interval between the two reference points located in the region where the torque transmission of the clutch is relatively high among the four reference points that have been moved, respectively, may be connected with or fitted using a straight line so as to simplify the calculation. A curve fitting may be performed only for the interval between the two middle reference points among the four reference points that have been moved with a spline curve through the four reference points so as to closely estimate the characteristics of the T-S curve of an actual clutch.

For reference, the reference points that have been newly moved are represented by P1′, P2′, P3′, and P4′ and the new T-S curve plotted accordingly is indicated with a dashed line in FIG. 4.

The method describe above makes it possible to quickly update an existing T-S curve so to greatly accurately follow the change in the characteristics of an actual clutch in accordance with an estimated point acquired in any methods while a vehicle is travelling, so as to control an actuator according to a T-S curve which has been newly updated when controlling the actuator of the clutch later and to more accurately control the clutch.

According to the present invention, it is possible to more appropriately control a dry type clutch and to ultimately improve the drivability of a vehicle having an automated manual transmission mounted thereon, by making it possible to estimate in real time a map of torque transmission of the clutch according to the working stroke of an actuator of the dry type clutch used in the automated manual transmission while the vehicle is running.

For convenience in explanation and accurate definition in the appended claims, the terms “left” or “right”, “horizontal” or “vertical”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for estimating torque transmission characteristics of a dry type clutch comprising:
a data receiving step S10 for receiving information of an estimated point representing torque transmission of the clutch according to an actuator stroke acquired in real time while a vehicle is travelling;
a reference points moving step S20 for moving a series of four reference points selected on an existing line representing a change in the torque transmission of the clutch according to the actuator stroke, based on the received information of the estimated point; and
an update step S30 for newly plotting a line representing the change in the torque transmission of the clutch according to the actuator stroke, using the four reference points which have been moved.

2. The method of claim 1, wherein the four reference points located on the line representing the change in the torque transmission of the clutch according to the actuator stroke are selected such that, with respect to a midpoint of a full range of the torque transmission a clutch can exert, two reference points are located in a low torque region where the torque transmission of the clutch is relatively low and the other two reference points are located in a high torque region where the torque transmission of the clutch is relatively high.

3. The method of claim 2, wherein a reference point which has the lowest torque transmission of the clutch among the four reference points is a touch point of the clutch.

4. The method of claim 2, wherein the two reference points selected in the low torque region represent a linear change interval in the torque transmission of the clutch according to the actuator stroke in the low torque region and the two reference points selected in the high torque region represent a linear change interval in the torque transmission of the clutch according to the actuator stroke in the high torque region, thereby ensuring drivability of the vehicle while performing control of the clutch.

5. The method of claim 4, wherein in the update step S30,
the two reference points selected in the low torque region among the four reference points that have been moved are connected by a straight line;
the two reference points selected in the high torque region among the four reference points that have been moved are connected by a straight line; and
two middle reference points among the four reference points that have been moved are connected by a portion of a spline curve that passes through the four reference points.

6. The method of claim 1, wherein in the reference points moving step S20,
a position corresponding to the torque transmission of the same magnitude as the estimated point entered in the data input step S10 is selected on the existing line representing the change in the torque transmission of the clutch according to the actuator stroke as a present point; and
the four reference points are moved based on a difference in stroke between the present point and the estimated point.

7. The method of claim 6, wherein when the four reference points are moved according to the difference in the stroke between the present point and the estimated point in the reference points moving step S20, an amount of movement of the four reference points varies in a direction of torque transmission and in a direction of stroke according to a relative positional difference between the four reference points and the estimated point.
